(19) United States
(12) Patent Application Publication
(10) Pub. No.: US 2017/0287018 A1
(43) Pub. Date: Oct. 5, 2017

(54) METHODS AND SYSTEMS FOR PERFORMING AN ADVERTISEMENT-BASED ELECTRONIC TRANSACTION

(71) Applicant: Omnyway, Inc., Redwood City, CA (US)

(72) Inventors: Ashok Narasimhan, San Francisco, CA (US); Mohammad Khan, San Jose, CA (US); William N. Melton, San Francisco, CA (US)

(21) Appl. No.: 15/629,488

(22) Filed: Jun. 21, 2017

Related U.S. Application Data
(63) Continuation-in-part of application No. PCT/US2016/054028, filed on Sep. 27, 2016.
(60) Provisional application No. 62/233,427, filed on Sep. 27, 2015.

(51) Int. Cl. G06Q 30/02; G06Q 20/20

(52) U.S. Cl. CPC G06Q 30/0277; G06Q 20/204

(57) ABSTRACT

Methods and systems for performing an advertisement-based electronic transaction are provided. According to one aspect, a system for performing an advertisement-based electronic transaction comprises a mobile backend server comprising a network interface, one or more processors, and memory. The mobile backend server receives, from a first electronic device, first information for identifying the user and second information for identifying an advertisement; identifies the user based on the first information; identifies an advertisement based on the second information; identifies a transaction object associated with the identified advertisement; determines transaction information for an electronic transaction involving the identified transaction object; determines payment information for the identified user; and initiates an electronic transaction using the transaction information and payment information. The first electronic device may be a mobile phone that captures the second information by scanning a QR code or by displaying an advertisement that the user clicks, touches, or otherwise selects.

### PRIORITY CLAIM

This application is a Continuation In Part of international application serial number PCT/US2016/054028, filed Sep. 27, 2016, which claims the benefit of U.S. provisional patent application Ser. No. 62/233,427, filed Sep. 27, 2015, the disclosures of which are hereby incorporated herein by reference in their entireties.

### TECHNICAL FIELD

This disclosure relates to performing secure financial and non-financial electronic transactions made by consumers. More specifically, it relates to methods and systems for performing an advertisement-based electronic transaction, such as an ecommerce transaction, using an electronic device, such as a mobile device.

### BACKGROUND

Electronic payments, ecommerce transactions, and the like, have evolved from requiring a physical credit card with information encoded on a magnetic stripe that must be “swiped” at a physical card reader (a so-called “card present” or “CP” transaction), to the use of the credit card information (card number, cardholder name, etc.) on ecommerce sites, for example (a so-called “card not present” or “CNP” transaction). Both of these conventional types of transactions, however, rely on the use or presence of merchant equipment, such as a Point Of Sale (POS) terminal in the case of the CP transaction and an ecommerce website in the case of a CNP transaction. The ultimate destination for the transaction information is typically an electronic payment network, such as the Visa™ payment network, that acts as the mechanism by which funds are transferred from the buyer to the seller of an electronic transaction, for example.

As used herein, the term “Point Of Sale (POS) terminal” refers to a device, typically merchant- or seller-owned or controlled, with which a user interacts in order to perform a payment or non-payment transaction. Typical POS terminals include cash registers and credit card readers. The term “ecommerce website” refers to an online entity, typically merchant- or seller-controlled, that provides an ecommerce portal to the user wherein the user can select items, add them to a checkout list or virtual shopping cart, and initiate a purchase which is handled by the ecommerce website.

### SUMMARY

The subject matter disclosed herein comprises methods and systems for performing an advertisement-based electronic transaction using an electronic device.

According to one aspect, the subject matter described herein comprises a method for performing an advertisement-based electronic transaction. In one embodiment, the method comprises, at a mobile backend server (MBS) comprising a network interface and one or more processors: receiving, from a first electronic device, first information for identifying the user and second information for identifying an advertisement; identifying the user based on the first information; identifying an advertisement-based on the second information; identifying a transaction object associated with the identified advertisement; determining transaction information for an electronic transaction involving the identified transaction object; determining payment information for the identified user; and initiating an electronic transaction using the transaction information and payment information.

In one embodiment, the method further comprises providing the transaction information and payment information to a payment transaction network.

In one embodiment, the method further comprises receiving, from the payment network, a result of the electronic transaction and reporting the result to the user.

In one embodiment, the transaction object comprises an item, a service, and/or a transaction.

In one embodiment, receiving the first information comprises receiving: information that directly or indirectly identifies the user; information that directly or indirectly identifies the first electronic device; a geographic location of the user or electronic device; a network address of the first electronic device; a billing address of the user; a shipping address of the user; and/or a payment information of the user.

In one embodiment, receiving the second information comprises receiving an Advertisement ID (AdID) and wherein determining the transaction object comprises mapping the AdID to the transaction object that is associated with the AdID.

In one embodiment, determining transaction information comprises communicating with a merchant data server (MDS) that provides transaction information.

In one embodiment, determining payment information comprises querying a database for storing and maintaining payment information for mobile users to retrieve the payment information.

In one embodiment, receiving the second information comprises capturing or scanning, by the first electronic device, or selecting through clicking or touching, via a display associated with the first electronic device, a graphic element that contains the second information in encoded form, decoding the graphic element to extract the second information, and sending the second information to the MBS;

In one embodiment, the graphic element comprises: text, a quick response (QR) code, a barcode, an image, and/or an image with data steganographically encoded within the image.

As used herein, the term “encoded steganographically” refers to the encoding of data within an image (which may also be an image of text) in such a way that the presence of the data within the image is not obvious. An example of steganographic encoding includes manipulating an image such that the least significant bit value of each pixel within the image, when aggregated into a string of bits, reconstruct the data being hidden within the image.

In one embodiment, receiving the second information comprises receiving or recording an audio sample that is presented or played from an advertisement and that contains the second information encoded as sound and decoding the audio sample to extract the second information.

In one embodiment, receiving the second information comprises receiving the second information via a wireless signal through a wireless interaction between the first electronic device and a second device that makes the advertisement available to the first electronic device.

In one embodiment, determining the transaction information comprises interacting with the user for: selecting item options; selecting payment options; selecting shipment options; selecting incentives; redeeming rewards; authenticating the user; and/or authorizing the transaction.

In one embodiment, the method further comprises, after identifying the transaction object and prior to determining the transaction information: sending, to the first electronic device, information identifying the transaction object, the information identifying the transaction object including options available for the identified transaction object; and receiving, from the first electronic device, information identifying options selected for the identified transaction object.

In one embodiment, the method further comprises, after determining the transaction information for the electronic transaction and prior to determining the payment information for the identified user: sending, to the first electronic device, the transaction information; receiving, from the first electronic device, approval or disapproval of the electronic transaction; upon receiving approval of the electronic transaction, proceeding to the determining the payment information step; and upon receiving disapproval of the electronic transaction, terminating the process.

In one embodiment, the method further comprises, prior to determining the payment information: identifying a second electronic device; establishing communication with the identified second electronic device; and communicating with the identified second electronic device.

In one embodiment, communicating with the identified second electronic device comprises: sending, to the second electronic device of the user, information identifying the transaction object, the information identifying the transaction object including options available for the identified transaction object; and receiving, from the second electronic device, information identifying options selected for the identified transaction object.

In one embodiment, communicating with the identified second electronic device comprises: sending, to the second electronic device, the transaction information; receiving, from the second electronic device, approval or disapproval of the electronic transaction; upon receiving approval of the electronic transaction, proceeding to the determining the payment information step; and upon receiving disapproval of the electronic transaction, terminating the process.

According to another aspect, the subject matter described herein comprises a system for performing an advertisement-based electronic transaction. In one embodiment, the system comprises: a MBS comprising a network interface, one or more processors, and memory storing instructions executable by the one or more processors, whereby the MBS is operable to: receive, from a first electronic device, first information for identifying the user and second information for identifying an advertisement; identify the user based on the first information; identify an advertisement-based on the second information; identify a transaction object associated with the identified advertisement; determine transaction information for an electronic transaction involving the identified transaction object; determine payment information for the identified user; and initiate an electronic transaction using the transaction information and payment information.

In one embodiment, the transaction object comprises an item, a service, and/or a transaction.

In one embodiment, the second information comprises an AdID and wherein the MBS identifies the transaction object by querying a database for storing and maintaining an association between AdIDs and transaction objects.

In one embodiment, the MBS determines transaction information by communicating with a MDS that provides transaction information.

In one embodiment, the MBS determines payment information by querying a database for storing and maintaining payment information for mobile users to retrieve the payment information.

In one embodiment, the MBS initiates an electronic transaction by sending transaction information and payment information to a MDS and/or a payment transaction network.

In one embodiment, prior to determining the payment information, the MBS: identifies a second electronic device; establishes communication with the identified second electronic device; and communicates with the identified second electronic device.

In one embodiment, communicating with the identified second electronic device comprises: sending, to the second electronic device, information identifying the transaction object, the information identifying the transaction object including options available for the identified transaction object; and receiving, from the second electronic device, information identifying options selected for the identified transaction object.

In one embodiment, communicating with the identified second electronic device comprises: sending, to the second electronic device, the transaction information; receiving, from the second electronic device, approval or disapproval of the electronic transaction; upon receiving approval of the electronic transaction, proceeding to the determining the payment information step; and upon receiving disapproval of the electronic transaction, terminating the process.

In one embodiment, the MBS is operable to: store and maintain an association between an AdID for identifying an advertisement that the AdID represents; generate an advertisement that contains the AdID; and provide the generated advertisement to the first electronic device.

In one embodiment, providing the generated advertisement to the first electronic device comprises: providing the generated advertisement to a display of the first electronic device; providing the generated advertisement as a graphic element that is captured or scanned by the first electronic device; providing the generated advertisement as a graphic element that is clicked or touched by the user on the first electronic device; providing the generated advertisement as an audio sample that is received by the first electronic device; and/or providing the generated advertisement as a wireless signal that is received by the first electronic device.

In one embodiment, generating an advertisement that contains an AdID comprises: generating a barcode or QR code that contains the AdID; generating an audio sample that contains the AdID; generating a wireless signal that contains the AdID; generating an image that contains the AdID steganographically encoded; and providing a graphic element on a webpage that, when clicked or selected by the user, transmits the AdID to the MBS.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for performing an advertisement-based electronic transaction according to an embodiment of the subject matter described herein;

FIG. 2 is a flow chart illustrating an exemplary process for performing an advertisement-based electronic transaction according to an embodiment of the subject matter described herein;

FIG. 3 is signal messaging diagram illustrating messages communicated among components of an exemplary system for performing an advertisement-based electronic transaction according to an embodiment of the subject matter described herein;

FIG. 4 is signal messaging diagram illustrating messages communicated among components of an exemplary system for performing an advertisement-based electronic transaction according to an embodiment of the subject matter described herein;

FIG. 5 is signal messaging diagram illustrating messages communicated among components of an exemplary system for performing an advertisement-based electronic transaction according to an embodiment of the subject matter described herein;

FIG. 6 is a block diagram illustrating an exemplary system for performing an advertisement-based electronic transaction according to another embodiment of the subject matter described herein;

FIG. 7 is signal messaging diagram illustrating messages communicated among components of an exemplary system for performing an advertisement-based electronic transaction according to an embodiment of the subject matter described herein;

FIG. 8 is a block diagram illustrating a MBS according to an embodiment of the subject matter described herein; and

FIG. 9 is a block diagram illustrating an electronic device according to an embodiment of the subject matter described herein.

### DETAILED DESCRIPTION

With the advent and ubiquity of smart phones, an opportunity has arisen to use the inherent network capabilities of a smart phone, mobile device, or other electronic device to engage in transactions that ultimately end up as an electronic transaction performed on an electronic payment network, but without the overhead of POS terminals or ecommerce websites. Having the ability to engage in purchases of goods and services or other types of commerce transaction free from these conventional encumbrances creates an entirely new type of sales channel that can drive consumer impulse buying with a minimum of resistance.

Being able to perform an ecommerce transaction using only an application on a mobile phone, for example, without the traditional infrastructure of POS terminals or ecommerce websites makes possible the ability to perform ecommerce transactions potentially anywhere. The user need only be able to identify the desired goods or services unambiguously using his or her electronic device; the rest of the process can take place in the background via secure channels. This technique is well suited for endowing internet ads, pop-up ads, pop-under ads, and other types of advertisements with the ability to effect an ecommerce or other type of electronic transaction simply by displaying a QR code, a bar code, or any other type of visual, aural, or even haptic information within the advertisement, which the ad viewer scans or otherwise captures with a mobile device, thus triggering the transaction, which is processed by a backend server, for example.

Such a transaction is referred to herein as an “advertisement-based electronic transaction”. Such transactions may be ecommerce transactions or other financial transactions, but may also be non-financial transactions. Financial transactions may be CNP transactions or CP transactions. Here, the term “advertisement” is used in its broadest meaning, i.e., to refer to any means by which a merchant or seller can advertise or make public the fact that goods or services are available for purchase, etc.

Methods and systems for performing an advertisement-based electronic transaction are provided herein. An advertisement-based electronic transaction takes place between a mobile or other electronic device (which may also be referred to herein as “the first electronic device” or simply “the electronic device”) and a payment network without requiring any of the conventional intervening entities, such as POS terminals or ecommerce websites. In an advertisement-based transaction, an electronic transaction may be performed using just two pieces of information received over a potentially insecure connection: (a) information that directly or indirectly identifies the user of the first electronic device; and (b) information that directly or indirectly identifies a particular advertisement. The former information is used to identify the user and then to retrieve payment information for that user from secure storage. The latter information is used to identify an advertisement and then to identify a “transaction object” that is associated with the identified advertisement. A transaction object may be a good, a service, and/or a transaction. These two pieces of information may be received from an electronic device owned or controlled by the user, such as a cell phone, or from an electronic device not owned or controlled by the user but used by the user, such as an electronic display, in-store kiosk, and the like.

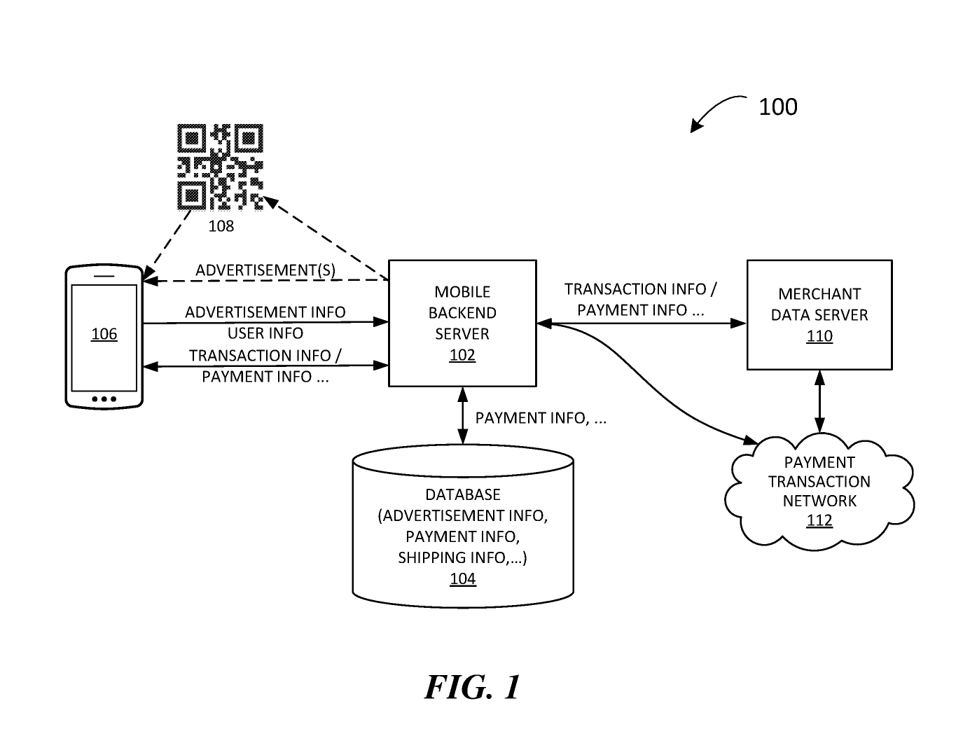

FIG. 1 is a block diagram illustrating an exemplary system for performing an advertisement-based electronic transaction according to an embodiment of the subject matter described herein. In the embodiment illustrated in FIG. 1, system 100 comprises a mobile backend server (MBS) 102 that communicates with a database 104 database for storing and maintaining various types of information, which may include advertisement information as well as payment and shipping information for mobile users.

The MBS 102 receives, from an electronic device 106 of a user, information for identifying an advertisement in which the user has shown an interest. In FIG. 1, this information is labeled “advertisement info” and may be alternatively referred to as “advertisement information”. The MBS 102 then uses the advertisement information to identify a transaction object that is associated with the advertisement. In one embodiment, the MBS 102 used the advertisement information received from the electronic device 106 to query database 104 to retrieve information about the transaction object that is associated with the advertisement. In one embodiment, the advertisement information may be provided to the electronic device 106 in the form of a graphic element, such as a QR code 108, which is scanned by the electronic device 106. In another embodiment, the advertisement may be displayed on the electronic device 106, and when the user clicks on, selects, or otherwise indicates interest in the advertisement, the advertisement information is transmitted by the electronic device 106 to the MBS 102.

In one embodiment, the item information is provided by a merchant or other provider of goods or services. In the embodiment illustrated in FIG. 1, system 100 also comprises a merchant data server (MDS) 110, which is typically owned or operated by the merchant/provider and which may act as intermediary between the MBS 102 and a payment transaction network 112. The MDS 110 may also be referred to as a manufacturer data server, a seller data server, a distributor data server, and so on. It is noted that the MDS 110 is not a traditional ecommerce server, in that it need not contain the functionality required to provide a web interface, maintain a shopping cart, process payments, or other functions performed by ecommerce servers. The MDS 110 may be thought of as a database server—an electronic catalog of sorts. This allows the MDS 110 to have very streamlined functionality. The functions of the components of system 100 will be described in more detail below.

In the embodiment illustrated in FIG. 1, the MBS 102 may also receive information about the user (herein referred to as “user information”). The MBS 102 may use the user information to query database 104 to retrieve payment information that is ultimately sent to an entity that performs an ecommerce transaction. In the embodiment illustrated in FIG. 1, that entity is the payment transaction network 112 (which may also be referred to herein as “payment network 112”), but other ecommerce transaction entities are also contemplated, including those that perform non-payment ecommerce transactions.

Advertisement information may include, but is not limited to, any information that uniquely identifies an advertisement. The identified advertisement is associated with a transaction target. It is noted that in at least one embodiment, the advertisement information has meaning only to the MBS 102. Should the advertisement information be intercepted between the first electronic device 106 and the MBS 102, for example, the intercepting party would not be able to use the intercepted data for malicious purposes, because the advertisement information does not contain payment information or any other confidential information that may be used to commit financial fraud.

In one embodiment, the advertisement information may be an AdID. An AdID need not include any discernable description of the object being advertised. For example, an AdID may be a random number, a string of characters, a binary data stream, and so on. In one embodiment, the MBS 102 uses the AdID to query database 104 to retrieve information about the transaction object that is associated with the advertisement. An AdID may be unique to each transaction object, or it may represent a class of transaction objects. Advertisements for the same transaction object may all have the same AdID or each instance or copy of the advertisement may have its own unique AdID. An AdID may be dynamically generated (e.g., to be displayed on a webpage) or statically generated (e.g., to be encoded in a QR code on a printed item).

In one embodiment, the AdID may contain information that helps the advertiser determine how the user saw or was otherwise exposed to the advertisement. For example, an AdID may include: the date and time that it was generated or deployed; the geographical location where it was deployed or viewed; information about the producer, distributor, or retailer of the transaction target; and so on.

User information may include, but is not limited to, information for identifying the user seeking the transaction, whether or not the user owns electronic device 106 (e.g., in case the user is using a friend's mobile device); information for identifying the electronic device 106 itself; the current location of the user or the electronic device 106; a billing address of the user; a shipping address of the user; a shipping preference of the user; a payment preference of the user; and so on.

Payment information may include, but is not limited to, information that is provided by a traditional magnetic stripe card or smart payment cards, such as primary account number, cardholder name, account holder name, expiration date, common short code (CSC) data, the name of the issuing bank, billing address, shipping address, etc. In one embodiment, the payment information is tokenized, in which case the payment information may be a token that contains encoded payment information or that contains information that may be redeemed to determine payment information.

In one example, a user may see a poster that includes an advertisement for a particular product. The advertisement may display a QR code 108, which the user scans with his or her smart phone. An application on the smart phone decodes the QR code, which contains a unique AdID. The application on the smart phone sends the AdID, along with information for identifying the user, to a MBS, which uses the AdID to look up the associated product (via a query to a database that maps AdIDs to products or services, for example). The MBS retrieves payment information for the user (e.g., credit card information the user's preferred credit card) and determines transaction information about the item. The MBS may optionally present that information to the user for selection of quantity, size, color, or other options and/or for final approval before initiating an electronic transaction, e.g., with a payment transaction network.

In another example, the user may see an advertisement displayed on the screen of the first electronic device 106, and when the user taps, clicks, or otherwise selects the advertisement, the application transmits the advertisement information and user information to the MBS 102. In one embodiment, the advertisement may be associated with javascript or other code executed by the first electronic device 106 that is triggered when the user taps the advertisement.

In yet another example, the first electronic device 106 may detect a beacon, radio frequency identifier (RFID) tag, or other near-field communication (NFC) signal that advertises a product, service, etc. In response, an application on the first electronic device 106 may ask the user whether the user has any interest in the item being advertised. If the user expresses interest, the advertisement information and user information may be transmitted to the MBS 102. In one embodiment, an application on the first electronic device 106 may continually monitor the screen and detect that there is a QR code being displayed on its own screen and extract the QR code directly.

Examples of other sources for the advertisement information include, but are not limited to: bar codes, which the electronic device 106 can scan; NFC beacons, which transmit data that the electronic device 106 can receive; images of text, which the electronic device 106 can capture and on which it can perform optical character recognition (OCR); pictures or other graphic elements which include data steganographically encoded within them (e.g., not visible to the human eye but detectable by an application); and audio samples that can be received by/recorded by the first electronic device 106 and decoded to extract the advertisement information encoded therein.

Transaction information may include, but is not limited to, information about the item, service, or transaction, and information about the merchant or provider. Such information may include, but is not limited to, the name or description of the item or service, Stock-Keeping Unit (SKU) number, or other type of description; a price of the item or service; the merchant, seller, or provider of the item or service; the location of the physical item being sold, the service being provided, and/or the point of purchase; the date and time of the transaction; and any other type of information. Transaction information may also include a characteristic of an item, such as color, size, style, etc., a quantity of the item or service, a price of the item or service, etc.

Transaction information may initially be speculative. For example, an advertisement may be associated with an article of clothing generally but without specifying a particular color or size. Thus, the transaction information initially provided by the MDS 110 may be for an article having a default size and color selection, as well as information that indicates what other sizes/colors are available. This transaction information may be forwarded to the user's electronic device 106 so that the user can make a selection of a specific size, color, quantity, etc. Thus, the transaction information that is ultimately sent to the payment transaction network 112 may be different from, or a subset of, the transaction information initially provided by the MDS 110.

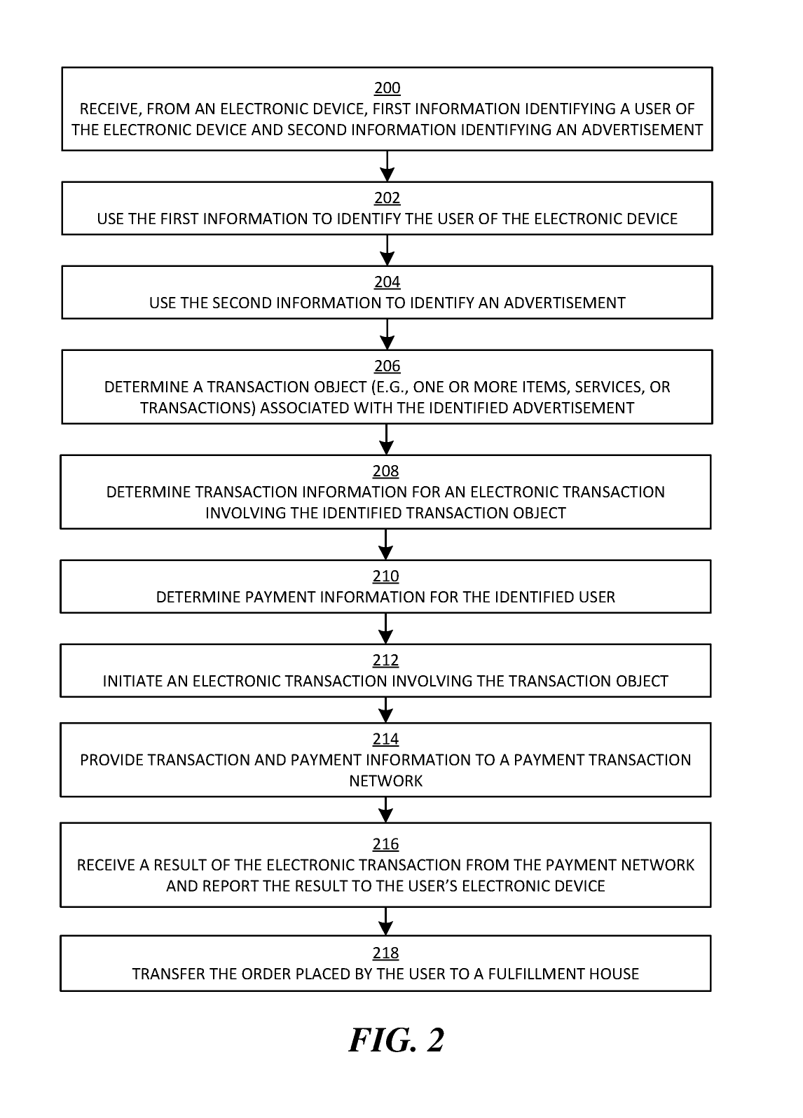

FIG. 2 is a flow chart illustrating an exemplary process for performing an advertisement-based electronic transaction according to another embodiment of the subject matter described herein. In the embodiment illustrated in FIG. 2, the method comprises the following steps, which will be described in reference to the example system 100 in FIG. 1.

At step 200, an MBS 102 receives, from an electronic device associated with a user, first information identifying a user of the computing device and second information identifying an advertisement. In the embodiment illustrated in FIG. 1, for example, the first electronic device 106 may scan the QR code 108 that is displayed within an advertisement displayed to the user via a web browser, for example. In one embodiment, the QR code 108 contains an AdID for identifying an advertisement that is associated with the item or service being advertised.

At step 202, the MBS 102 uses the first information to identify the user of the first electronic device 106. In one embodiment, the MBS 102 may use the first information to query a user identification database stored within database 104.

At step 204, the MBS 102 uses the second information to identify an advertisement. In one embodiment, the MBS 102 may use the second information to query an advertisement database stored within database 104.

At step 206, the MBS 102 determines a transaction object (e.g., one or more item(s), service(s), and/or transaction(s), etc.) associated with the identified advertisement. In one embodiment, the MBS 102 may use the identified advertisement (e.g., an AdID) to query a product database stored within database 104.

At step 208, the MBS 102 determines payment information for the identified user. In one embodiment, the MBS 102 may use the user identity to query a payment database stored within database 104.

At step 210, the MBS 102 determines transaction information for an electronic transaction involving the identified transaction object. In the embodiment illustrated in FIG. 1, for example, MBS 102 may communicate with MDS 110 to determine transaction information, such as cost of goods including tax and shipping, etc.

At step 212, the MBS 102 initiates an electronic transaction involving the transaction object. In some embodiments, this may include performing user verification, transaction authorization, and/or user approval as a prerequisite. For example, failure to verify the user, authorize the transaction, or receive user approval may result in the electronic transaction not being initiated.

At step 214, the MBS 102 provides the transaction information and payment information to a payment transaction network 112, either directly or via MDS 110. The payment transaction network 112 may perform a Card Present (CP) or Card Not Present (CNP) ecommerce transaction.

At step 216, the MBS 102 receives, from the payment transaction network 112, a result of the electronic transaction. For example, payment transaction network 112 may report whether the ecommerce transaction passed or failed. This report or notification may be sent to the first electronic device 106, to the MBS 102, and/or to MDS 110. In the embodiment illustrated in FIG. 1, the MBS 102 reports the result to the user's computing device 106.

At step 218, the order placed by the user is transferred to a fulfillment house.

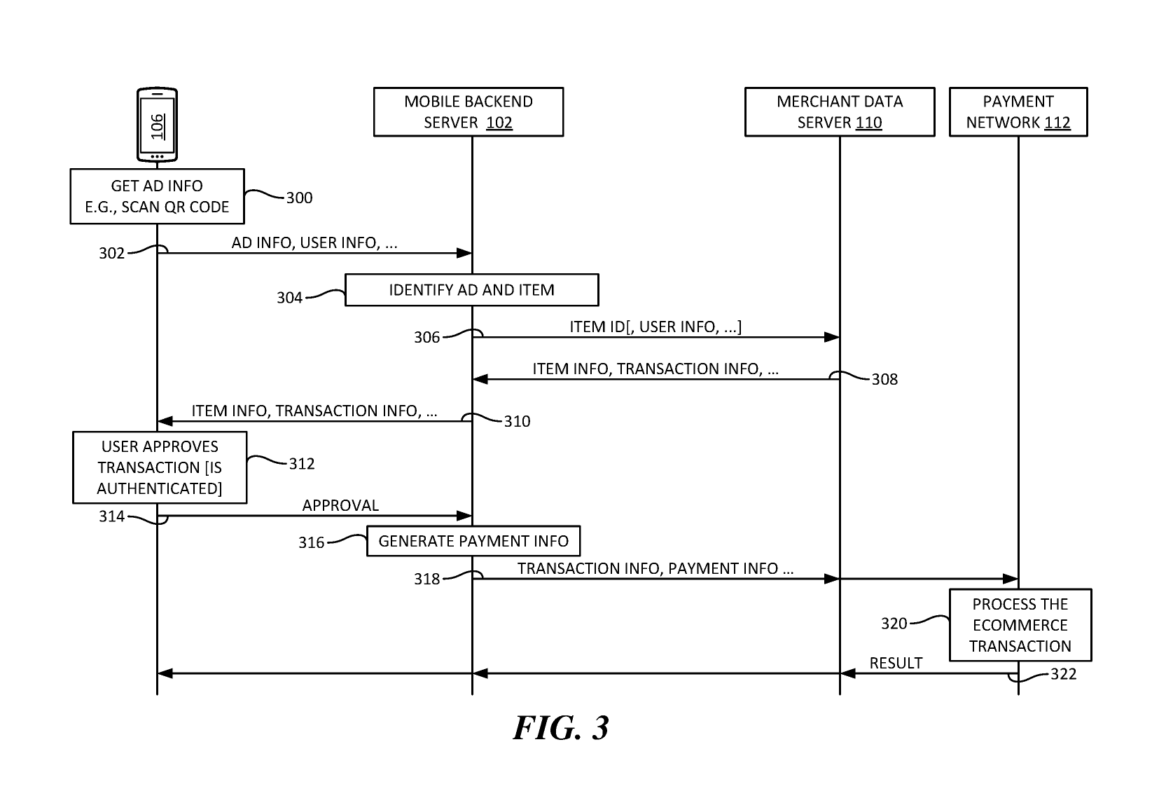

An example operation of system 100 will now be described in more detail using FIG. 3. It will be understood that the phrase “information for identifying <X>” may refer to information that directly identifies the object X or information that indirectly identifies X. Examples of the former include, but are not limited to, the name of a person, the address of a building, the description of an item, etc. Examples of the latter include, but are not limited to, a key or search term that may be used to identify an entry in a database that contains information about the object, etc.

FIG. 3 is a signal messaging diagram illustrating messages communicated among components of an exemplary system for performing an advertisement-based electronic transaction according to an embodiment of the subject matter described herein. In the embodiment illustrated in FIG. 3, at block 300, a user of an electronic device 106 gets information for identifying an advertisement for an item of interest. The item of interest may be a product, such as an item on a shelf, an item displayed in an advertisement or print catalog, kiosk, or screen, etc. The item of interest may be a service, such as a manicure, a membership in a health club, a year of lawn care, etc. The item of interest may be a transaction, such as a money transfer, a stock purchase, etc. The item of interest may be, but is not limited to, anything which may be the subject of or related to an ecommerce transaction.

In one example scenario, a user may be presented with an advertisement that offers the user with an opportunity to purchase an airplane ticket. Once the user has entered the travel information and selected dates and times for the flight(s), the advertisement may display a QR code, which the user scans with electronic device 106. The QR code contains information, such as an AdID, for identifying the advertisement. The advertisement information may be received by electronic device 106 via other means, including, but not limited to, transmission via NFC or other wireless protocol, such as Wi-Fi, WiMAX, 802.11, cellular, infrared (IR), audio, video, still image, manual entry, bar codes, or other available methods.

In one embodiment, once electronic device 106 has received the advertisement information, electronic device 106 sends the advertisement information to the MBS 102 (message 302). In the embodiment illustrated in FIG. 3, electronic device 106 also comprises user information in message 302.

The MBS 102 receives the advertisement information and uses that information to identify the advertisement and the transaction object associated with that advertisement (block 304). (For simplicity of discussion, it is assumed that, in the following example, the transaction object associated with the advertisement is an item. Information for identifying the item is referred to as an “item identifier” or “item ID”.)

In one embodiment, MBS 102 may use the item ID to identify an MDS 110 which is associated with the merchant or entity that is offering the item for sale or providing the desired service. In this scenario, MBS 102 may communicate with the identified MDS 110 (message 306), e.g., to verify that the item or service is available for purchase and/or delivery. In one embodiment, message 306 may include user information as well, which allows MDS 110 to use the user's shipping address or shipping preference to determine shipping costs, to offer discounts or additional deals to the user, and so on. In response, MDS 110 may provide to MBS 102 additional item information and/or transaction information (message 308).

Additional item information may include, but is not limited to, confirmation that the item is available, a list of available colors, styles, and/or sizes (e.g., in the case of clothing or footwear), proposed substituted goods or services (e.g., if the desired good or service is unavailable), additional items that the user may want to consider, etc.

Transaction information may include, but is not limited to, the total cost of the item, including tax and/or shipping, an estimated delivery date, the source of the goods or provider of the services, and so on.

In one embodiment, MBS 102 may apply rules to determine whether the transaction should (still) be allowed or otherwise control the behavior of the payment instrument. In the example illustrated in FIG. 3, the transaction has not been blocked, and therefore MBS 102 sends the item information and transaction information (message 310) to electronic device 106, which may display that information to the user for final approval of the transaction (block 312). In one embodiment, electronic device 106 may require user authentication, such as the entry of a password, pass phrase, PIN, or biometric verification, before or at the same time that the user indicates approval of the transaction at block 314.

In one embodiment, the item and transaction information may indicate to the user that the user has received a discount. For example, the user may be presented with the discounted price, which may be shown as an absolute price, a relative price compared with the undiscounted price (shown as a relative number, relative percentage, or both, for example), or some combination of the above.

In the scenario illustrated in FIG. 3, the user approves the transaction. Electronic device 106 sends notification of that approval to MBS 102 (message 314). Once approval is received, MBS 102 may generate payment information (block 316). In one embodiment, MBS 102 may query database 104 to retrieve the payment information associated with the user of electronic device 106. In one embodiment, MBS 102 may have previously authenticated the combination of mobile user and payment information (or some combination of mobile user, electronic device 106, and payment information, for example). This payment information may be selected based on the user's preference or other user info and may be constrained or modified by the application of other rules.

In the embodiment illustrated in FIG. 3, MBS 102 may then forward at least some of the payment information along with the transaction information to a payment transaction network 112 (message 318), which processes the ecommerce transaction (block 320) and reports the result of the transaction (message 322) back to the MDS 110, to the MBS 102, and/or to the first electronic device 106 (and by extension to the user of the electronic device 106.) In one embodiment, message 318 is sent directly to payment transaction network 112. In an alternative embodiment, message 318 is sent to payment transaction network 112 via MDS 110.

In one embodiment, the ecommerce transaction may be processed as a CP transaction or as a CNP transaction, depending on what information payment transaction network 112 receives from MBS 102. For example, if the payment information generated at block 316 comprises a CSC1 value, payment transaction network 112 may process the payment as a CP transaction. Alternatively, if the payment information comprises a CSC2 value (or no CSC but a billing address instead), payment transaction network 112 may process the payment as a CNP transaction.

The sequences of messages and actions illustrated in FIG. 3 are illustrative and not limiting. Other embodiments are also within the scope of the subject matter described herein. For example, in one alternative embodiment, MBS 102 may skip the rule application entirely, and may instead apply no rules at all or apply rules at other points in the process.

In another alternative embodiment, the interaction between MBS 102 and MDS 110, represented by messages 306 and 308, may occur at a different time in the process or may be skipped entirely.

In yet another alternative embodiment, steps 310, 312, and 314 may be skipped entirely, i.e., user final approval of the transaction is not sought.

In one embodiment, the functions of MBS 102 may be integrated with the functions of MDS 110. In these embodiments, system 100 may contain one or the other of MBS 102 and MDS 110, but not both. In the embodiment illustrated in FIG. 1, MBS 102 and MDS 110 are shown as distinct entities. They may be logically or physically distinct/separate from each other.

In one embodiment, one or more backend servers (e.g., 102 and/or 110) may receive the item information and user information and calculate the transaction information, including using the user information to determine which, if any, discounts are available to the user, e.g., based on the user's choice of payment instrument, the user's membership in a rewards club, and so on. In an alternative embodiment, some or all of this determination may be performed by electronic device 106. For example, an application running on electronic device 106 may send a request to one of the backend servers to provide a list of discounts that might be available for the product or service that is the subject of the electronic transaction. Rental car companies, for example, may offer a discounted rate to consumers who are over a certain age, to consumers who are members of a particular professional organization, to consumers who use a particular bank card, to consumers who have a particular type of auto insurance, and so on. Electronic device 106 may request and receive such a list, and then use that list to determine which discount or combination of discounts is the most financially attractive and notify the backend server(s) that the particular discount or combination of discounts is to be applied to the transaction. Likewise, other distributions of labor and/or decision-making are contemplated.

In another embodiment, electronic device 106 may notify the user that he or she qualifies a discount and prompts the user to decide whether or not to take the discount Likewise, the user may be notified that multiple discounts are available and may be prompted to select one of the discounts (if mutually exclusive) or to select multiple discounts (if not mutually exclusive). In another embodiment, the user of electronic device 106 may be presented with a dynamically updated price or transaction cost that changes based on multiple criteria, which may include, but is not limited to, the selections that the user makes during the completion of the transaction.

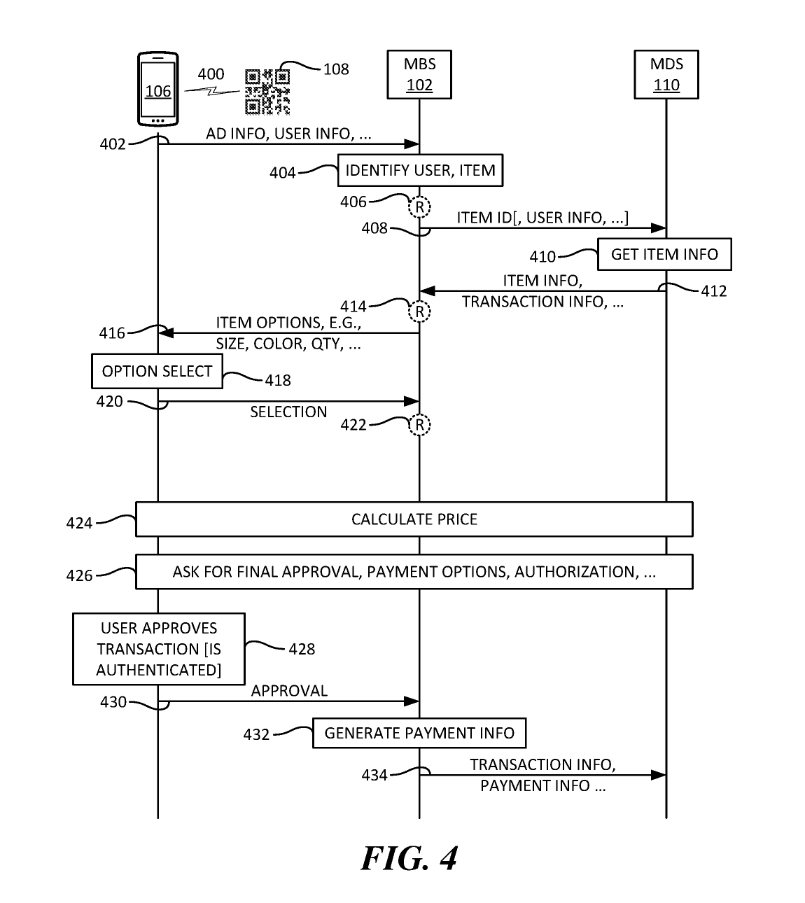

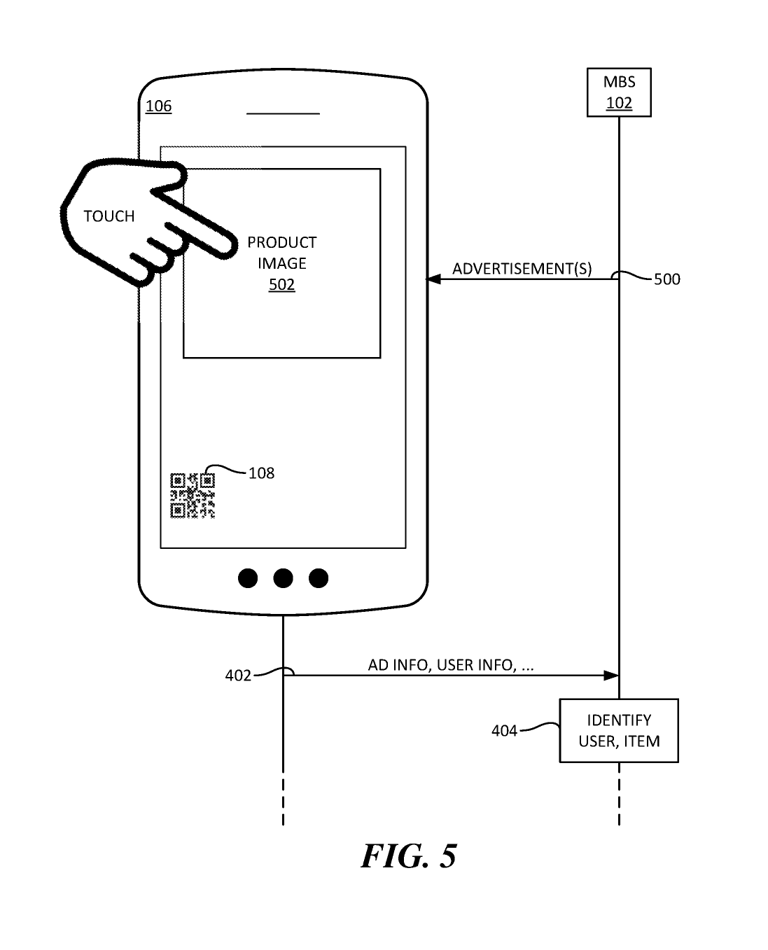

FIG. 4 is signal messaging diagram illustrating messages communicated among components of an exemplary system for performing an advertisement-based electronic transaction according to an embodiment of the subject matter described herein. In the embodiment illustrated in FIG. 4, a user may use his or her electronic device 106 to receive information about an advertisement (referred to herein as “advertisement information”). In one embodiment, this may occur when the first electronic device 106 scans a QR code 108, shown as data transfer 400. This may be controlled by a mobile application running on the first electronic device 106, which decodes the QR code to extract from it the advertisement information. The advertisement information may directly or indirectly identify an advertisement. (In other embodiments, such as will be illustrated in FIG. 5, below, the advertisement is displayed on the screen of the first electronic device 106, which the user may click on, touch, or otherwise select.)

The first electronic device 106 then conveys the advertisement information along with information that directly or indirectly identifies the user of the first electronic device 106 (referred to herein as “user information”) to the MBS 102. This is shown as message 402. In one embodiment, the mobile application is configured to know how to identify and connect to MBS 102, in which case the QR code 108 need not and does not include information for that purpose.

At block 404, upon receipt of the advertisement information and user information, the MBS 102 uses some or all of the user information to identify the user. The MBS 102 may then collect additional information about the user, e.g., from a database, such as database 104 in FIG. 1, which it may use for later steps of the process. Examples of such information include, but are not limited to, user name, user address, user purchase history, user preferences including but not limited to preferred payment instrument, preferred shipping method, etc., spending limits, budget limits, and other types of information.

The MBS 102 also uses the advertisement information to identify an advertisement and then identify the transaction object that is associated with that advertisement. (For simplicity of discussion, it is assumed that the transaction object associated with the advertisement is an item. Information for identifying the item is referred to as “item identification” or “item ID”.)

In one embodiment, MBS 102 may apply a set of rules that control whether or not a particular transaction should be allowed, based on which user is requesting the transaction, based on what products or services are involved in the transaction, based on whether transaction limits have been exceeded, and so on. In the embodiment illustrated in FIG. 4, at element 406, MBS 102 may apply rules right away to make sure that the item is one that the user is allowed to purchase. For example, an underage user of electronic device 106 may be prohibited from purchasing alcohol. In this scenario, the application of rules at block 406 may result in MBS 102 denying the attempted transaction, in which case the process would stop there. In the embodiment illustrated in FIG. 4, it is assumed that the application of the rules did not result in the transaction being blocked. Rules may be applied by MBS 102 at any point during the process. Likewise, in one embodiment, MBS 102 may not be configured to support or apply any rules. Application of such rules is represented as a dotted circle containing the letter “R”, such as elements 406, 414, and 422 shown in FIG. 4. Other opportunities to apply such rules are considered within the scope of the present disclosure.

In the embodiment illustrated in FIG. 4, the item ID may, along with optional user information, be sent by the MBS 102 to a MDS 110 (shown as message 408). The item ID may identify an item directly, or the item ID may be used to indirectly identify an item. For example, the item ID may be a Universal Product Code (UPC), which the MDS 110 maps to a SKU number, or other information.

At block 410, the MDS 110 uses the item ID to get information about the identified item, referred to as “item information”. Examples of item information include, but are not limited to, price, description, availability, and zero or more options, including but not limited to color, pattern, style, size, length, width, height, or other options. In some scenarios, the user information may affect the content of the item information determined by the MDS 110. For example, a rewards club member may get a better price, have access to stock that is in limited supply, and so on. Other types of information may include, for items that are physically stored in a warehouse and will be shipped to the user upon completion of the transaction, the locations and distance to various warehouses as well as indications whether or not the item in question is available at each warehouse. This type of information may be considered item information, transaction information, or a hybrid.

The item information is then provided from the MDS 110 to the MBS 102 (message 412). Here again, rules may be applied (element 414). For example, the user may be a child who is using a parent's account to purchase goods, in which case the rules may apply to allow or deny the particular transaction. In another example, the rules may operate to prevent a minor from purchasing alcohol. Other types of rules may be applied here.

One aspect of the subject matter illustrated in FIG. 4 is the ability to notify the prospective purchaser when there are options associated with the subject of the transaction. In one example use case, a user may see an advertisement for a coat. The user may take a picture of the coat using his or her mobile device. The advertisement may include first information about the item encoded as a QR code, steganographic information, and so on, which the mobile app decodes and sends via the MBS 102 to the MDS 110. The MDS 110 may determine that the item in question comes in only a few sizes or colors, and provides this information about available sizes and colors to the MBS 102, which then presents the options to the user (message 416), who can then make one or more selections (block 418). The selection information is conveyed (message 420) back to the MBS 102, which may again apply rules (element 422).

After one or more items are scanned and options selected, then the price of the item may be calculated and optionally displayed to the user. Since this function could be performed at the first electronic device 106, at the MBS 102, at the MDS 110, or some combination of the above, this is represented in FIG. 4 by block 424. This may be repeated after each item is processed (e.g., after each QR code 108 is scanned), or it may be performed only after the user indicates that the item selection process is complete.

In the embodiment illustrated in FIG. 4, at block 426, the user is asked for final approval of the transaction. At this time, the user may select or indicate a desired payment instrument, may select or indicate desired payment options, and may also be authorized. Once the user approves the transaction (block 428), the first electronic device 106 sends an indication of such approval (message 430) to the MBS 102, which then generates payment information (credit card information, etc.) (block 432) to be sent to the MDS 110 (message 434). The MDS may then initiate the transaction with a payment network.

FIG. 5 is signal messaging diagram illustrating messages communicated among components of an exemplary system for performing an advertisement-based electronic transaction according to an embodiment of the subject matter described herein. In the embodiment illustrated in FIG. 5, the user is using his or her electronic device 106 to view a product displayed in an advertisement that was delivered to the electronic device from the MBS 102 (data transfer 500). The advertisement may comprise a product image 502, a QR code 108, text, or other graphic element. The advertisement may comprise an audio and/or video stream that contains encoded advertisement information detectable/extractable by the electronic device 106.

In one embodiment, the advertisement may include a product image 502. In one embodiment, the product image itself contains information about the product steganographically encoded within the image, and when the user touches the product image, the mobile application detects and decodes the steganographically-encoded data to get the advertisement information, which is sent to the MBS 102, e.g., using the same process as steps 402, 404, and so on, in FIG. 4.

In another embodiment, the user may touch a QR code 108, a bar code, text, or other element being displayed on the screen of the first electronic device 106, which triggers the mobile application to extract the advertisement information and send the advertisement information to the MBS 102.

In yet another embodiment, the product image, text, or other graphic element may be a clickable link that, when clicked upon or otherwise selected, triggers the transmittal of advertisement information and user information to the MBS 102.

It is noted particularly that the product image and QR code being displayed does not need to be part of an ecommerce website. The information within the image, QR code, etc., is used to identify the advertisement, and does not include any payment information, does not include any user information, and does not include any account information. The user information may be provided by the mobile application, the payment information may be provided by the MBS 102, and the account information may be provided by the MBS 102, the MDS 110, or both. This has several benefits: first, it allows the advertisement information to be very sparse; second, it allows the advertisement information to be displayed essentially anywhere; third, it allows the user to perform a transaction without using a POS terminal or an ecommerce website.

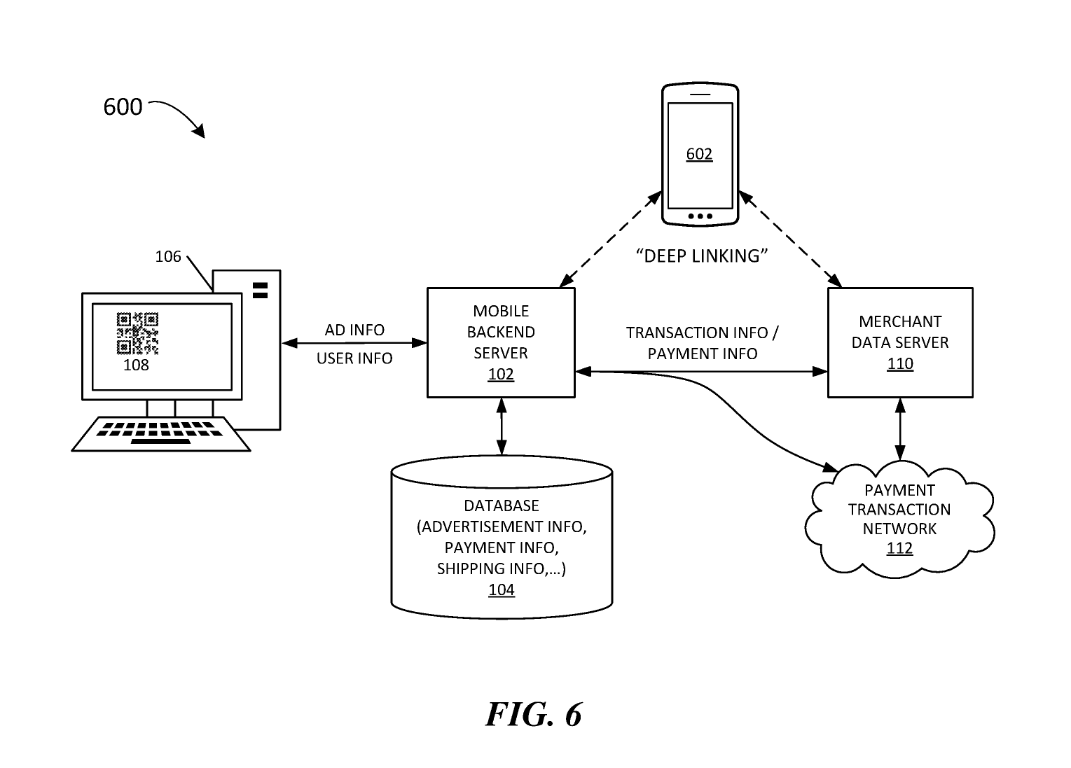

FIG. 6 is a block diagram illustrating an exemplary system for performing an advertisement-based electronic transaction according to another embodiment of the subject matter described herein. In the embodiment illustrated in FIG. 6, a system 600 comprises an MBS 102, a database 104, an electronic device 106 (which in this example, is a personal computer), an MDS 110, and a payment transaction network 112, which are essentially the same as the like-numbered elements of FIG. 1 and therefore their descriptions will not be repeated here. In the embodiment illustrated in FIG. 6, the first electronic device 106 is a computer upon which an advertisement, such as QR code 108, an image, etc., is displayed in an application, such as a web browser or a custom application. In one example, when the user clicks the QR code 108, the application connects to the MBS 102 and passes first information and user information to the MBS 102.

In one embodiment, the QR code 108, image, or other, is a link to a uniform resource locator (URL) that represents the MBS 102, and clicking on the link causes the first electronic device 106 to issue an HTTP PUT or GET that comprises parameters that identify the item or service being advertised, along with information from which the user may be directly or indirectly identified. From that point, either the MBS 102 or the MDS 110 may perform “deep linking”, i.e., establishing a connection to a second electronic device 602, such as a mobile phone, that is associated with the user that clicked on the link. Once the connection to the second electronic device 602 is established, the steps starting from 304 in FIG. 3 or starting from 404 in FIG. 4 may proceed as shown in those figures, respectively, i.e., using the second electronic device 602 rather than the first electronic device 106.

The linking may occur at the application level or at the operating system level. In one embodiment, for example, the user of a personal computer, his or her own electronic device, his or her own tablet or portable computer, or even a device owned by a merchant or person other than the user, may click on a QR code 108, text, an image, or other graphical element being displayed, which causes the MBS 102 to send a command or other message to the second electronic device 602, which in turn causes the second electronic device 602 to start an application that displays information about the item or transaction. The second electronic device 602 may then provide that second information to the MBS 102 or the MBS 102 may already have access to the second information before activating the application on the second electronic device 602.

In the example illustrated in FIG. 6, the first and second information are initially provided to the MBS 102 by a computer and the process is completed by a mobile phone, but the roles of computer and mobile phone could be swapped. For example, in an alternative embodiment, the first electronic device 106 may be a mobile phone and the second electronic device 602 may be a computer. Other alternative embodiments may involve additional electronic devices. For example, an additional electronic device may be involved in user identity verification, user authentication, transaction validation, payment authorization, etc.

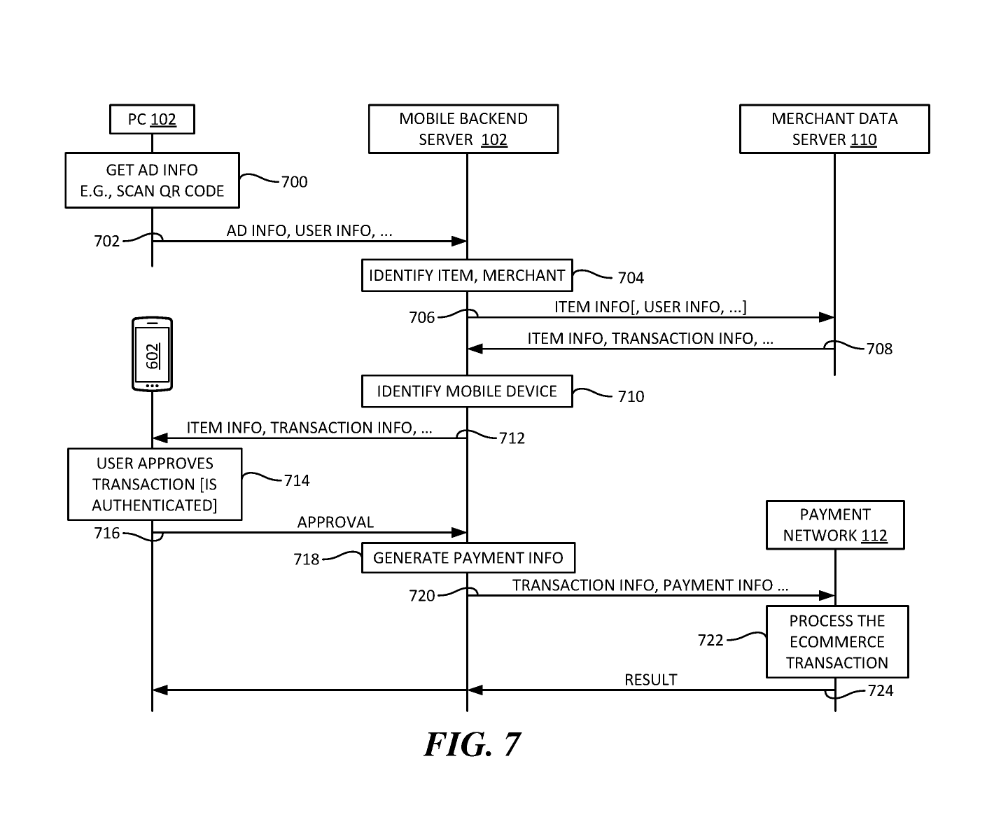

FIG. 7 is signal messaging diagram illustrating messages communicated among components of an exemplary system for performing an advertisement-based electronic transaction according to an embodiment of the subject matter described herein. In the embodiment illustrated in FIG. 7, at block 700, a user using a personal computer (PC) or other electronic device 106 other than the user's mobile phone 602, gets information about an advertisement (referred to generically as “advertisement info”). This information and user information are both communicated to a MBS 102 (message 702).

The MBS 102 uses the advertisement information to identify an advertisement, which is then used to identify the transaction object that is associated with that advertisement. (Here also, it is assumed that the transaction object associated with the advertisement is an item, and information for identifying the item is referred to as an “item identifier” or “item ID”.) In the embodiment illustrated in FIG. 7, the MBS 102 uses the item information to identify a merchant (block 704). The MBS 102 identifies an MDS 110 that provides data for that merchant's products and communicates with that MDS 110 (messages 706 and 708) to retrieve item information and perhaps transaction information as well. The MBS 102 also identifies a second electronic device 602 of the user (block 710) and establishes communication with that second electronic device 602, which in this example is a mobile phone.

In the embodiment illustrated in FIG. 7, the MBS 102 then sends the item and transaction information (message 712) to the second electronic device 602, so that the user may, for example, make item selections, such as size, color, quantity, and so on, as well as select a payment option (or make no selection, in which case the default payment for that user will be used by the MBS 102), select coupons or other incentives to be applied, until the user ultimately decides whether to approve the transaction or not (block 714). In one embodiment, the second electronic device 602 may authenticate the user.

If the user approves (message 716), the MBS 102 generates transaction/payment information (block 718), which is then sent to the payment transaction network 112 (message 720). The payment transaction network 112 processes the ecommerce transaction (block 722) and reports the result (message 724).

In the embodiment illustrated in FIG. 7, the MBS 102 communicates directly with the payment transaction network 112 to perform the ecommerce transaction, but in alternative embodiments, the MBS 102 may send this information via the MDS 110 or another network entity which handles transaction-related activities, such as fulfillment, coupon reconciliation, rewards/points updates, and so on.

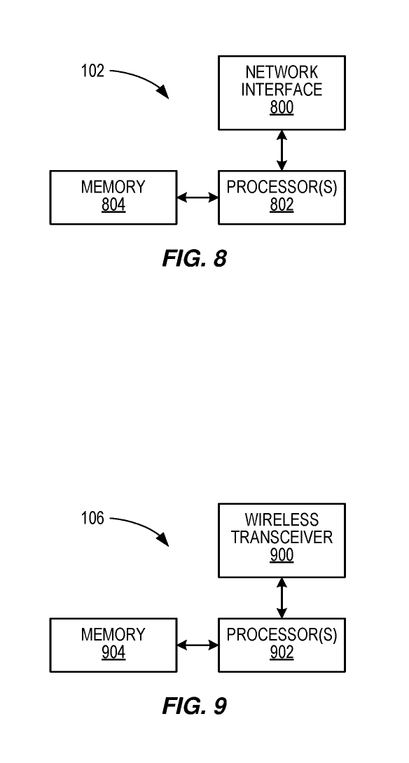

FIG. 8 is a block diagram illustrating a MBS 102 according to an embodiment of the subject matter described herein. In the embodiment illustrated in FIG. 8, MBS 102 includes a network interface 800 for communicating with a telecommunication network, one or more processors 802, and memory 804 for storing instructions executable by one or more of the processors 802. The MBS 102 is operable to perform any of the methods and functions disclosed herein.

FIG. 9 is a block diagram illustrating an electronic device 106 according to an embodiment of the subject matter described herein. In the embodiment illustrated in FIG. 9, electronic device 106 includes a wireless transceiver 900 for communicating with a wireless network, one or more processors 902, and memory 904 for storing instructions executable by the one or more processors 902. The first electronic device 106 is operable to receive, from an advertisement available to the electronic device 106, first information about an advertisement, and send, to a MBS for storing and maintaining payment information for mobile users, the advertisement information, and information about the user.

The concept of performing an advertisement-based electronic transaction has a wide range of applications, including, but not limited to, the following examples and use cases.

Physical (so-called “brick and mortar”) stores with a wide variety of products but limited space sometimes have “virtual aisles”, which may be kiosks or other display areas, that display products for which there is no space in the physical store. A shopper who sees an item of interest displayed on the virtual aisle can use his or her mobile device to scan a QR code that is displayed with or otherwise associated with the image of the item of interest. The mobile device can decode the QR code to extract information about an advertisement for the item or transaction and use the extracted information to perform an ecommerce transaction directly with a payment network. In one embodiment, the ecommerce transaction may include shipping and delivery of the purchased good right to the buyer's home, office, or other location from the warehouse. In one embodiment, a store may display a copy of the most current sales catalog, flyer, or mailer showing goods or services on sale.

The QR code or other information can be displayed via a wide variety of advertising media, including, but not limited to, being printed on a surface and being displayed on visual display, such as a dynamic advertisement display.

The MBS can perform additional functions, including, but not limited to, providing a discount to a user based on the user's profile, membership in a rewards or loyalty program, use of promotional codes, shipping preferences, etc. The MBS may apply rules that limit what kind of ecommerce transactions are available to the user, the device, the payment instrument to be used, or some combination of the above. For example, a child may scan a QR code to purchase a product but the MBS may block that purchase unless the purchase is authorized by an administrator (e.g., unless the parent allows it.) In this scenario, the parent may get a notification on his or her mobile phone that a child is attempting a purchase, and the ecommerce transaction is not allowed unless the parent authorizes that transaction.

### Additional Embodiments

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

Embodiment 1: A system for performing an advertisement-based electronic transaction using a mobile device, the system comprising a database for storing and maintaining payment information for mobile users, and a MBS for storing user information including payment information, the MBS comprising one or more processors and memory storing instructions executable by the one or more processors, whereby the MBS receives, from a mobile device of a user, first information about an item or transaction, wherein the mobile device received the first information from an advertisement available to the mobile device, and second information about the user, that processes the first and second information to determine transaction information and to generate payment information, and that sends the transaction and payment information to a payment network for processing the ecommerce transaction. The first information may be information for identifying an advertisement for the item or transaction.

Embodiment 2: The system of embodiment 1 wherein receiving the first information comprises scanning, by the mobile device, text or an image that contains the first information in encoded form and decoding the text or image to extract the first information.

Embodiment 3: The system of embodiment 1 wherein receiving the first information comprises receiving the first information via an email, via a text message, via a multimedia message, or via an application hosted by the mobile device.

Embodiment 4: The system of embodiment 1 wherein receiving the first information comprises selecting text or an image being displayed on the mobile device, the text or image containing the first information in encoded form, and decoding the text or image to extract the first information.

Embodiment 5: The system of embodiment 1 wherein receiving the first information comprises selecting, by a computing device other than the mobile device, text or an image being displayed on the computer device other than the mobile device, the text or image containing the first information in encoded form, and decoding the text or image to extract the first information.

Embodiment 6: The system of any of embodiments 2 to 5 wherein the text or image comprises a QR code image or bar code image.

Embodiment 7: The system of any of embodiments 2 to 5 wherein the text or image comprises a text image and wherein decoding the image comprises performing optical character recognition on the text image to extract the first information.

Embodiment 8: The system of any of embodiments 2 to 5 wherein the text or image comprises an image that contains information that is encoded steganographically within the image.

Embodiment 9: The system of any of embodiments 1 to 8 wherein receiving the first information comprises receiving or recording an audio sample that is presented or played from an advertisement and that contains the first information encoded as sound and decoding the audio sample to extract the first information.

Embodiment 10: The system of any of embodiments 1 to 9 wherein receiving the first information comprises receiving the first information via a wireless signal through a wireless interaction with a device that makes the advertisement available to the mobile device.

Embodiment 11: The system of embodiment 10 wherein receiving the first information via a wireless signal through a wireless interaction with the device that makes the advertisement available to the mobile device comprises at least one of: communicating using a NFC protocol; communicating using a radio frequency (RF) protocol; receiving the first information from a RFID chip; and communicating using an IR communication protocol.

Examples of RF protocols include, but are not limited to, wireless, including cellular, Wi-Fi, and Wi-MAX, Bluetooth™, Bluetooth Low Energy (BLE)™, and others.

Embodiment 12: The system of any of embodiments 1 to 11 wherein the first information comprises at least one of: information that directly identifies the item or transaction; information that indirectly identifies the item or transaction; and information that indicates a source from which information about the item or transaction may be received, which may be an advertisement, for example.

Embodiment 13: The system of any of embodiments 1 to 12 wherein sending second information about the user comprises sending at least one of: information for identifying the user; information for identifying the mobile device; a current location of the user or mobile device; a billing address of the user; a shipping address of the user; a shipping preference of the user; and a payment preference of the user.

Embodiment 14: The system of any of embodiments 1 to 13 wherein determining transaction information comprises communicating with a MDS that provides transaction information or transaction object information.

Embodiment 15: The system of any of embodiments 1 to 14 wherein the transaction information comprises at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

Embodiment 16: The system of any of embodiments 1 to 15 wherein determining transaction information comprises applying rules that govern or control the ability of the user to request the transaction or the ability of the payment instrument or financial account to perform the transaction.

Embodiment 17: The system of any of embodiments 1 to 16 wherein generating payment information comprises querying a database for storing and maintaining payment information for mobile users to retrieve the payment information.

Embodiment 18: The system of any of embodiments 1 to 17 wherein generating payment information comprises generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

Embodiment 19: The system of any of embodiments 1 to 18 wherein sending transaction information and payment information to a payment network comprises: sending the transaction and payment information to the payment network directly; or sending the transaction and payment information to the payment network via a MDS.

Embodiment 20: The system of any of embodiments 1 to 19 wherein the ecommerce transaction is a CP transaction.

Embodiment 21: The system of any of embodiments 1 to 20 wherein the ecommerce transaction is a CNP transaction.

Embodiment 22: The system of any of embodiments 1 to 21 wherein the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

Embodiment 23: The system of any of embodiments 1 to 22 wherein determining transaction information comprises getting user final approval to perform the transaction and/or authenticating the user.

Embodiment 24: The system of embodiment 23 wherein authenticating the user by the mobile device comprises receiving, at the mobile device, identification information for identifying the user and authentication information for authenticating the identity of the user and using the authentication information to authenticate the identity of the user.

Embodiment 25: The system of embodiment 24 wherein the information for identifying or authenticating the identity of the user comprises at least one of: a name of the user; an address of the user; an identification number associated with the user; biometric information provided by the user; a password, passcode, or personal information number (PIN) of the user; a digital signature of the user, a geo-location of the user, or information from the user's social network.

Embodiment 26: The system of embodiment 24 wherein authentication of the identity of the user is performed by the mobile device.

Embodiment 27: The system of embodiment 24 wherein the backend mobile server receives from the mobile device identification information and authentication information and uses the received information to authenticate the user.

Embodiment 28: The system of embodiment 24 wherein the identification or authentication information is provided by the user or by entity different from the user.

Embodiment 29: A method for performing an advertisement-based electronic transaction using a mobile device, the method comprising, at a mobile device associated with a user: receiving, from an advertisement available to the mobile device, first information about an item or transaction; and sending, to a MBS for storing and maintaining payment information for mobile users, the first information and second information about the user; at the MBS: processing the first and second information to determine transaction information and to generate payment information for an ecommerce transaction; and sending the transaction information and payment information to a payment network for processing the ecommerce transaction. The first information may be information for identifying an advertisement for the item or transaction.

Embodiment 30: The method of embodiment 29 wherein receiving the first information comprises scanning, by the mobile device, text or an image that contains the first information in encoded form and decoding the text or image to extract the first information.

Embodiment 31: The method of embodiment 29 wherein receiving the first information comprises receiving the first information via an email, via a text message, via a multimedia message, or via an application hosted by the mobile device.

Embodiment 32: The method of embodiment 29 wherein receiving the first information comprises selecting text or an image being displayed on the mobile device, the text or image containing the first information in encoded form, and decoding the text or image to extract the first information.

Embodiment 33: The method of embodiment 29 wherein receiving the first information comprises selecting, by a computing device other than the mobile device, text or an image being displayed the computing device other than the mobile device, the text or image containing the first information in encoded form, and decoding the text or image to extract the first information.

Embodiment 34: The method of any of embodiments 30 to 33 wherein the text or image comprises a QR code image or bar code image.

Embodiment 35: The method of any of embodiments 30 to 33 wherein the text or image comprises a text image and wherein decoding the image comprises performing optical character recognition on the text image to extract the first information.

Embodiment 36: The method of any of embodiments 29 to 35 wherein receiving the first information comprises receiving or recording an audio sample that is presented or played from an advertisement and that contains the first information encoded as sound and decoding the audio sample to extract the first information.

Embodiment 37: The method of any of embodiments 29 to 36 wherein receiving the first information comprises receiving the first information via a wireless signal through a wireless interaction with a device that makes the advertisement available to the mobile device.

Embodiment 38: The method of embodiment 37 wherein receiving the first information via a wireless signal through a wireless interaction with the device that makes the advertisement available to the mobile device comprises at least one of: communicating using a NFC protocol; communicating using a radio frequency (RF) protocol; receiving the first information from a RFID chip; and communicating using an IR communication protocol.

Embodiment 39: The method of any of embodiments 29 to 38 wherein the first information comprises at least one of: information that directly identifies the item or transaction; information that indirectly identifies the item or transaction; and information that indicates a source from which information about the item or transaction may be received, which may be an advertisement, for example.

Embodiment 40: The method of any of embodiments 29 to 39 wherein sending second information about the user comprises sending at least one of: information for identifying the user; information for identifying the mobile device; a current location of the user or mobile device; a billing address of the user; a shipping address of the user; a shipping preference of the user; and a payment preference of the user.

Embodiment 41: The method of any of embodiments 29 to 40 wherein determining transaction information comprises communicating with a MDS that provides transaction information or transaction object information.

Embodiment 42: The method of any of embodiments 29 to 41 wherein the transaction information comprises at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

Embodiment 43: The method of any of embodiments 29 to 42 wherein determining transaction information comprises applying rules that govern or control the ability of the user to request the transaction or the ability of the payment instrument or financial account to perform the transaction.

Embodiment 44: The method of any of embodiments 29 to 43 wherein generating payment information comprises querying a database for storing and maintaining payment information for mobile users to retrieve the payment information.

Embodiment 45: The method of any of embodiments 29 to 44 wherein generating payment information comprises generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

Embodiment 46: The method of any of embodiments 29 to 45 wherein sending transaction information and payment information to a payment network comprises: sending the transaction and payment information to the payment network directly; or sending the transaction and payment information to the payment network via a MDS.

Embodiment 47: The method of any of embodiments 29 to 46 comprising processing the ecommerce transaction by the payment network.

Embodiment 48: The method of embodiment 47 to comprising reporting the result of the ecommerce transaction back to at least one of MBS, the mobile device, and the user.

Embodiment 49: The method of any of embodiments 29 to 48 wherein the ecommerce transaction is a CP transaction.

Embodiment 50: The method of any of embodiments 29 to 49 wherein the ecommerce transaction is a CNP transaction.

Embodiment 51: The method of any of embodiments 29 to 50 wherein the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

Embodiment 52: The method of any of embodiments 29 to 51 wherein determining transaction information comprises getting user final approval to perform the transaction and/or authenticating the user.

Embodiment 53: The method of embodiment 52 wherein authenticating the user by the mobile device comprises receiving, at the mobile device, identification information for identifying the user and authentication information for authenticating the identity of the user and using the authentication information to authenticate the identity of the user.

Embodiment 54: The method of embodiment 53 wherein the information for identifying or authenticating the identity of the user comprises at least one of: a name of the user; an address of the user; an identification number associated with the user; biometric information provided by the user; a password, passcode, or personal information number (PIN) of the user; a digital signature of the user, a geo-location of the user, or information from the user's social network.

Embodiment 55: The method of embodiment 53 wherein authentication of the identity of the user is performed by the mobile device.

Embodiment 56: The method of embodiment 53 comprising, at the backend mobile server, receiving from the mobile device identification information and authentication information and using the received information to authenticate the user.

Embodiment 57: The method of embodiment 53 wherein the identification or authentication information is provided by the user or by entity different from the user.

Embodiment 58: A method for performing an advertisement-based electronic transaction without the involvement of a point of sale terminal or an ecommerce website, the method comprising: at a MBS for storing user information including payment information, receiving, from a first electronic device, first information for identifying the user and second information for identifying an item or transaction; using the first information to identify the user and generating payment information for the identified user; using the second information to identify a MDS that provides item or transaction information, communicating with the identified MDS to identify the item or transaction and to receive third information about the identified item or transaction, and communicating the third information about the identified item or transaction to the user; upon receiving an instruction from the user, sending the transaction information and payment information to a payment network for processing an electronic transaction.

Embodiment 59: The method of embodiment 58 wherein the first information comprises at least one of: information that directly or indirectly identifies the user; information that directly or indirectly identifies the first electronic device; a geographic location of the user or electronic device; a network address of the first electronic device; a billing address of the user; a shipping address of the user; and a payment preference of the user.

Embodiment 60: The method of embodiment 58 or 59 wherein the second information comprises information that directly or indirectly identifies the item or transaction.

Embodiment 61: The method of embodiment 58 or 59 wherein the second information comprises information for identifying a location of item or transaction information within a database for storing item or transaction information.

Embodiment 62: The method of any of embodiments 58 to 61 wherein receiving the second information comprises receiving a graphic element via an email, via a text message, via a multimedia message, or via an application hosted by the first electronic device.

Embodiment 63: The method of any of embodiments 58 to 62 wherein receiving the second information comprises scanning, by the first electronic device, a graphic element that contains the second information in encoded form, decoding the graphic element to extract the second information, and sending the second information to the MBS.

Embodiment 64: The method of any of embodiments 58 to 63 wherein receiving the second information comprises selecting, via a display associated with the first electronic device, a graphic element that contains the second information in encoded form, decoding the graphic element to extract the second information, and sending the second information to the MBS.

Embodiment 65: The method of any of embodiments 58 to 64 wherein receiving the second information comprises selecting, via a display associated with the first electronic device, a graphic element that, when selected, causes the MBS to instruct the first electronic device to activate an application hosted by the first electronic device that provides the second information.

Embodiment 66: The method of any of embodiments 62 to 65 wherein the graphic element comprises at least one of: text, a QR code, a barcode, an image, and an image with data steganographically encoded within the image.

Embodiment 67: The method of any of embodiments 58 to 66 wherein receiving the second information comprises receiving the second information via a wireless signal through a wireless interaction between the first electronic device and a second device that makes the advertisement available to the first electronic device.

Embodiment 68: The method of embodiment 67 wherein receiving the second information via a wireless signal through a wireless interaction with the second device that makes the advertisement available to the mobile device comprises at least one of: communicating using a NFC protocol; communicating using a radio frequency (RF) protocol; communicating using an IR communication protocol; and receiving the second information from a RFID chip.

Embodiment 69: The method of any of embodiments 58 to 68 wherein receiving the second information comprises, at the first electronic device, receiving or recording an audio sample that is presented or played from the advertisement and that contains the second information encoded as sound, decoding the audio sample to extract the second information, and sending the second information to the MBS.

Embodiment 70: The method of any of embodiments 58 to 69 wherein communicating the third information about the identified item or transaction comprises interacting with the user for at least one of: selecting item options; selecting payment options; selecting shipment options; selecting incentives; redeeming rewards; authenticating the user; and authorizing the transaction.

Embodiment 71: The method of any of embodiments 58 to 70 wherein the first electronic device comprises a mobile device.

Embodiment 72: The method of any of embodiments 58 to 71 wherein the first electronic device comprises a computer and wherein communicating the third information about the identified item or transaction comprises identifying a mobile device, establishing a communication with the identified mobile device, and interacting with the mobile device.

Embodiment 73: The method of embodiment 71 or 72 wherein interacting with the mobile device comprises using the mobile device for at least one of: selecting item options; selecting payment options; selecting shipment options; selecting incentives; redeeming rewards; authenticating the user; and authorizing the transaction.

Embodiment 74: The method of any of embodiments 58 to 73 wherein sending the transaction and payment information to the payment network comprises sending the transaction and payment information to the payment network via a MDS.

Embodiment 75: A system for performing an advertisement-based electronic transaction without the involvement of a point of sale terminal or an ecommerce website, the system comprising a database for storing and maintaining payment information for mobile users, and a MBS for storing user information including payment information, the MBS comprising one or more processors and memory storing instructions executable by the one or more processors, whereby the MBS receives, from a first electronic device, first information for identifying the user and second information for identifying an item or transaction; uses the first information to identify the user and generating payment information for the identified user; uses the second information to identify a MDS that provides item or transaction information, communicates with the identified MDS to identify the item or transaction and to receive third information about the identified item or transaction, and communicates the third information about the identified item or transaction to the user; and, upon receiving an instruction from the user, sends the transaction information and payment information to a payment network for processing an electronic transaction.

Embodiment 76: The system of embodiment 75 wherein the first information comprises at least one of: information that directly or indirectly identifies the user; information that directly or indirectly identifies the first electronic device; a geographic location of the user or electronic device; a network address of the first electronic device; a billing address of the user; a shipping address of the user; and a payment preference of the user.

Embodiment 77: The system of embodiment 75 or 76 wherein the second information comprises information that directly or indirectly identifies the item or transaction.

Embodiment 78: The system of embodiment 75 or 76 wherein the second information comprises information for identifying a location of item or transaction information within a database for storing item or transaction information.

Embodiment 79: The system of any of embodiments 75 to 78 wherein receiving the second information comprises receiving a graphic element via an email, via a text message, via a multimedia message, or via an application hosted by the first electronic device.

Embodiment 80: The system of any of embodiments 75 to 79 wherein receiving the second information comprises scanning, by the first electronic device, a graphic element that contains the second information in encoded form, decoding the graphic element to extract the second information, and sending the second information to the MBS.

Embodiment 81: The system of any of embodiments 75 to 80 wherein receiving the second information comprises selecting, via a display associated with the first electronic device, a graphic element that contains the second information in encoded form, decoding the graphic element to extract the second information, and sending the second information to the MBS.

Embodiment 82: The system of any of embodiments 75 to 81 wherein the graphic element comprises at least one of: text, a QR code, a barcode, an image, and an image with data steganographically encoded within the image.

Embodiment 83: The system of any of embodiments 75 to 82 wherein receiving the second information comprises receiving the second information via a wireless signal through a wireless interaction between the first electronic device and a second device that makes the advertisement available to the first electronic device.

Embodiment 84: The system of embodiment 83 wherein receiving the second information via a wireless signal through a wireless interaction with the second device that makes the advertisement available to the mobile device comprises at least one of: communicating using a NFC protocol; communicating using a radio frequency (RF) protocol; communicating using an IR communication protocol; and receiving the second information from a RFID chip.

Embodiment 85: The system of any of embodiments 75 to 84 wherein receiving the second information comprises, at the first electronic device, receiving or recording an audio sample that is presented or played from the advertisement and that contains the second information encoded as sound, decoding the audio sample to extract the second information, and sending the second information to the MBS.

Embodiment 86: The system of any of embodiments 75 to 85 wherein communicating the third information about the identified item or transaction comprises interacting with the user for at least one of: selecting item options; selecting payment options; selecting shipment options; selecting incentives; redeeming rewards; authenticating the user; and authorizing the transaction.

Embodiment 87: The system of any of embodiments 75 to 86 wherein the first electronic device comprises a mobile device.

Embodiment 88: The system of any of embodiments 75 to 87 wherein the first electronic device comprises a computer and wherein communicating the third information about the identified item or transaction comprises identifying a mobile device of the user, establishing a communication with the identified mobile device, and interacting with the mobile device.

Embodiment 89: The system of embodiment 87 or 88 wherein interacting with the mobile device comprises using the mobile device for at least one of: selecting item options; selecting payment options; selecting shipment options; selecting incentives; redeeming rewards; authenticating the user; and authorizing the transaction.

Embodiment 90: The system of any of embodiments 75 to 89 wherein sending the transaction and payment information to the payment network comprises sending the transaction and payment information to the payment network via a MDS.

Embodiment 91: A non-transitory computer readable medium having stored thereon executable instructions that when executed by the processor of a computer control the computer to perform steps comprising: at a mobile device associated with a user: receiving, from an advertisement available to the mobile device, first information about an item or transaction; and sending, to a MBS for storing and maintaining payment information for mobile users, the first information and second information about the user; at the MBS: processing the first and second information to determine transaction information and to generate payment information for an ecommerce transaction; and sending the transaction information and payment information to a payment network for processing the ecommerce transaction.

### GLOSSARY OF ACRONYMS

AdID Advertisement Identifier
BLE Bluetooth Low Energy
CNP Card Not Present
CP Card Present
IR Infra-red
MBS Mobile Backend Server
MDS Merchant Data Server
NFC Near-Field Communication
OCR Optical Character Recognition
PC Personal Computer
PIN Personal Identification Number
POS Point-Of-Sale
QR Quick Response
RF Radio Frequency
RFID Radio Frequency Identifier
SKU Stock-Keeping Unit
UPC Universal Product Code
URL Universal Resource Locator

What is claimed is:

1. A method for performing an advertisement-based electronic transaction, the method comprising:
at a mobile backend server comprising a network interface and one or more processors:
receiving, from a first electronic device, first information for identifying a user and second information for identifying an advertisement;
identifying the user based on the first information;
identifying the advertisement based on the second information;
identifying a transaction object associated with the identified advertisement;
determining transaction information for an electronic transaction involving the identified transaction object;
determining payment information for the identified user; and
initiating the electronic transaction using the transaction information and payment information.

2. The method of claim 1 further comprising providing the transaction information and payment information to a payment transaction network.

3. The method of claim 2 further comprising receiving, from the payment transaction network, a result of the electronic transaction and reporting the result to the user.

4. The method of claim 1 wherein the transaction object comprises an item, a service, and/or a transaction.

5. The method of claim 1 wherein receiving the first information comprises receiving: information that directly or indirectly identifies the user; information that directly or indirectly identifies the first electronic device; a geographic location of the user or the first electronic device; a network address of the first electronic device; a billing address of the user; a shipping address of the user;
and/or the payment information of the user.

6. The method of claim 1 wherein receiving the second information comprises receiving an Advertisement Identifier (AdID) and wherein determining the transaction object comprises mapping the AdID to the transaction object that is associated with the AdID.

7. The method of claim 1 wherein determining the transaction information comprises communicating with a merchant data server that provides the transaction information.

8. The method of claim 1 wherein determining the payment information comprises querying a database for storing and maintaining the payment information for mobile users to retrieve the payment information.

9. The method of claim 1 wherein receiving the second information comprises capturing or scanning, by the first electronic device, or selecting through clicking or touching, via a display associated with the first electronic device, a graphic element that contains the second information in encoded form, decoding the graphic element to extract the second information, and sending the second information to the mobile backend server.

10. The method of claim 9 wherein the graphic element comprises: text, a quick response (QR) code, a barcode, an image, and/or an image with data steganographically encoded within the image.

11. The method of claim 1 wherein receiving the second information comprises receiving or recording an audio sample that is presented or played from an advertisement and that contains the second information encoded as sound and decoding the audio sample to extract the second information.

12. The method of claim 1 wherein receiving the second information comprises receiving the second information via a wireless signal through a wireless interaction between the first electronic device and a second electronic device that makes the advertisement available to the first electronic device.

13. The method of claim 1 wherein determining the transaction information comprises interacting with the user for: selecting item options; selecting payment options; selecting shipment options; selecting incentives; redeeming rewards; authenticating the user; and/or authorizing the transaction.

14. The method of claim 1 further comprising, after identifying the transaction object and prior to determining the transaction information:
sending, to the first electronic device of the user, information identifying the transaction object, the information identifying the transaction object including options available for the identified transaction object; and
receiving, from the first electronic device of the user, information identifying options selected for the identified transaction object.

15. The method of claim 1 further comprising, after determining the transaction information for the electronic transaction and prior to determining the payment information for the identified user:
sending, to the first electronic device of the user, the transaction information;
receiving, from the first electronic device of the user, approval or disapproval of the electronic transaction;
upon receiving approval of the electronic transaction, proceeding to the determining the payment information step; and
upon receiving disapproval of the electronic transaction, terminating the process.

16. The method of claim 1 further comprising, prior to determining the payment information:
identifying a second electronic device of the user;
establishing communication with the identified second electronic device; and
communicating with the identified second electronic device.

17. The method of claim 16 wherein communicating with the identified second electronic device comprises:
sending, to the second electronic device of the user, information identifying the transaction object, the information identifying the transaction object including options available for the identified transaction object; and
receiving, from the second electronic device of the user, information identifying options selected for the identified transaction object.

18. The method of claim 16 wherein communicating with the identified second electronic device comprises:
sending, to the second electronic device of the user, the transaction information; and
receiving, from the second electronic device of the user, approval or disapproval of the electronic transaction;
wherein upon receiving approval of the electronic transaction, determining the payment information; and
wherein upon receiving disapproval of the electronic transaction, terminating the process.

19. A system for performing an advertisement-based electronic transaction, the system comprising:
a mobile backend server comprising a network interface, one or more processors, and memory storing instructions executable by the one or more processors, whereby the mobile backend server is operable to:
receive, from a first electronic device, first information for identifying a user and second information for identifying an advertisement;
identify the user based on the first information;
identify the advertisement based on the second information;
identify a transaction object associated with the identified advertisement;
determine transaction information for an electronic transaction involving the identified transaction object;
determine payment information for the identified user; and
initiate the electronic transaction using the transaction information and payment information.

20. The system of claim 19 wherein the transaction object comprises an item, a service, and/or a transaction.

21. The system of claim 19 wherein the second information comprises an Advertisement Identifier (AdID) and wherein the mobile backend server identifies the transaction object by querying a database for storing and maintaining an association between AdIDs and transaction objects.

22. The system of claim 19 wherein the mobile backend server determines the transaction information by communicating with a merchant data server that provides the transaction information.

23. The system of claim 19 wherein the mobile backend server determines the payment information by querying a database for storing and maintaining the payment information for mobile users to retrieve the payment information.

24. The system of claim 19 wherein the mobile backend server initiates the electronic transaction by sending the transaction information and payment information to a merchant data server and/or a payment transaction network.

25. The system of claim 19 wherein, prior to determining the payment information, the mobile backend server:
identifies a second electronic device of the user;
establishes communication with the identified second electronic device; and
communicates with the identified second electronic device.

26. The system of claim 25 wherein communicating with the identified second electronic device comprises:
sending, to the second electronic device of the user, information identifying the transaction object, the information identifying the transaction object including options available for the identified transaction object; and
receiving, from the second electronic device of the user, information identifying options selected for the identified transaction object.

27. The system of claim 25 wherein communicating with the identified second electronic device comprises:
sending, to the second electronic device of the user, the transaction information; and
receiving, from the second electronic device of the user, approval or disapproval of the electronic transaction;
wherein upon receiving approval of the electronic transaction, determining the payment information; and
wherein upon receiving disapproval of the electronic transaction, terminating the process.

28. The system of claim 19 wherein the mobile backend server is operable to:
store and maintain an association between an Advertisement Identifier (AdID) for identifying an advertisement that the AdID represents;
generate an advertisement that contains the AdID; and
provide the generated advertisement to the first electronic device of the user.

29. The system of claim 28 wherein providing the generated advertisement to the first electronic device of the user comprises:
providing the generated advertisement to a display of the first electronic device;
providing the generated advertisement as a graphic element that is captured or scanned by the first electronic device;
providing the generated advertisement as a graphic element that is clicked or touched by the user on the first electronic device;
providing the generated advertisement as an audio sample that is received by the first electronic device; and/or
providing the generated advertisement as a wireless signal that is received by the first electronic device.

30. The system of claim 28 wherein generating an advertisement that contains an AdID comprises:
generating a barcode or QR code that contains the AdID;
generating an audio sample that contains the AdID;
generating a wireless signal that contains the AdID;
generating an image that contains the AdID steganographically encoded; and
providing a graphic element on a webpage that, when clicked or selected by the user, transmits the AdID to the mobile backend server.
